(19) United States
(12) Patent Application Publication
(10) Pub. No.: US 2026/0310526 A1
(43) Pub. Date: Oct. 8, 2026

(54) INTELLIGENT TRAFFIC SHAPER SCHEMA FOR AUGMENTED REALITY DEVICES

(71) Applicant: QUALCOMM Incorporated, San Diego, CA (US)

(72) Inventors: Karthik RANGARAJU, San Diego, CA (US); Salman Abdul KHALIQ, San Diego, CA (US); Ammar MAHMOOD, San Diego, CA (US); Udayakumar MENON, San Diego, CA (US)

(21) Appl. No.: 19/170,454

(22) Filed: Apr. 4, 2025

(51) Int. Cl. G06F 9/54; G06F 9/48

(52) U.S. Cl. CPC G06F 9/54; G06F 9/4843

(57) ABSTRACT

Aspects of the disclosure are directed to traffic shaping. In accordance with one aspect, the disclosure includes executing a plurality of dispatcher actions based on a plurality of profile pair parameters; using the plurality of dispatcher actions to determine a critical zone; generating a plurality of application programming interface (API) signals, wherein the plurality of API signals are synchronized to the critical zone; executing a feedback loop to adjust the critical zone based on an actual data to create an adjusted critical zone; and sending the plurality of API signals to at least one process for task realignment out of the critical zone or the adjusted critical zone.

### TECHNICAL FIELD

This disclosure relates generally to the field of information processing systems, and, in particular, to traffic shaping for augmented reality (AR) information processing systems.

### BACKGROUND

An augmented reality (AR) information processing system is designed to generate an immersive synthesis of physical reality and simulated products for an enhanced user experience. In general, the AR information processing system requires intensive computational and storage resources which may consume excessive energy. Thus, an alternative AR architecture with an intelligent traffic shaper schema may be desired for energy efficiency in an AR device.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides traffic shaping. Accordingly, the present disclosure discloses a method including: executing a plurality of dispatcher actions based on a plurality of profile pair parameters; using the plurality of dispatcher actions to determine a critical zone; generating a plurality of application programming interface (API) signals, wherein the plurality of API signals are synchronized to the critical zone; executing a feedback loop to adjust the critical zone based on an actual data to create an adjusted critical zone; and sending the plurality of API signals to at least one process for task realignment out of the critical zone or the adjusted critical zone.

Another aspect of the disclosure provides an apparatus including: a non-transitory memory configured to store a plurality of profile pair parameters; and an application processor coupled to the non-transitory memory, the application processor configured to determine a critical zone, to generate a plurality of application programming interface (API) signals, to execute a feedback loop to adjust the critical zone based on an actual data to create an adjusted critical zone, and to sending the plurality of API signals to at least one process for task realignment out of the critical zone or the adjusted critical zone..

Another aspect of the disclosure provides a non-transitory computer-readable medium storing computer executable code, operable on a device including at least one processor and at least one memory coupled to the at least one processor, wherein the at least one processor is configured to implement traffic shaping, the computer executable code including: instructions for causing a computer to execute a plurality of dispatcher actions based on a plurality of profile pair parameters; instructions for causing the computer to use the plurality of dispatcher actions to determine a critical zone; instructions for causing the computer to generate a plurality of application programming interface (API) signals, wherein the plurality of API signals are synchronized to the critical zone; and instructions for causing the computer to execute a feedback loop to adjust the critical zone based on an actual data.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example augmented reality (AR) device.

FIG. 3 illustrates an example of an intelligent traffic shaper schema.

FIG. 4 illustrates an example overview of an intelligent traffic shaping.

FIG. 5 illustrates an example of a first set of performance curves.

FIG. 6 illustrates an example of a second set of performance curves.

FIG. 7 illustrates an example of a third set of performance curves.

FIG. 8 illustrates an example of a fourth set of performance curves.

FIG. 9 illustrates an example energy consumption table.

FIG. 10 illustrates an example flow diagram for implementing intelligent traffic shaping.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), uses multiple levels of coordination or synchronization. In one example, a slice may include a processing engine (i.e., a subset of the computing system) as well as associated memory units and other peripheral devices. In one example, execution of an application may be decomposed into a workload which is executed by multiple slices or multiple processing engines. A plurality of processor cores may be part of each processing engine where a processor core is an independent processing element which may be operated in parallel with other processor cores. A plurality of processing engines may be aggregated into a processor cluster which shares certain system resources (e.g., cache memory).

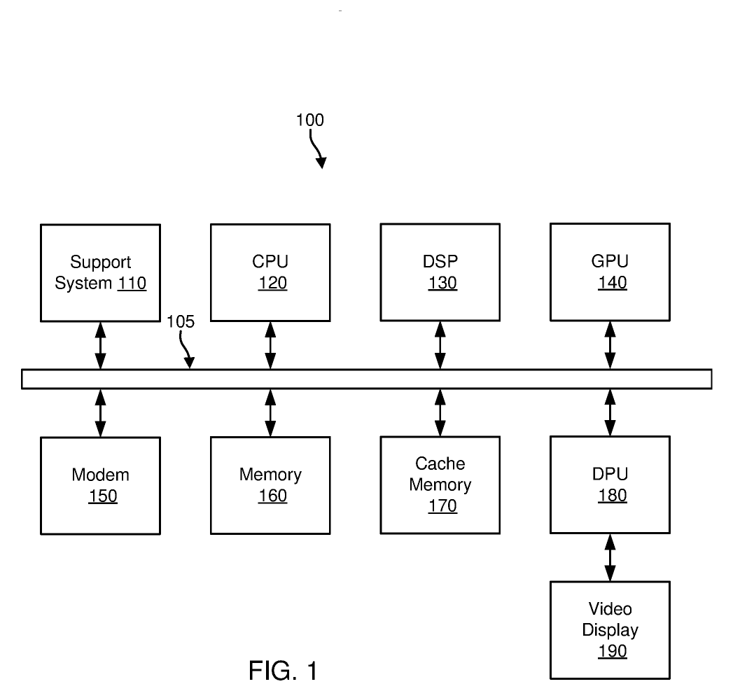

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. In one example, the CPU 120 may serve as a controller or a microcontroller of other processing engines. In one example, the controller or microcontroller may reallocate tasks from one processing engine to another. In one example, the controller or microcontroller may determine if a baseline workload partition should be reallocated using machine learning (ML) monitoring of system on a chip (SOC) temperatures.

In one example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines. Although several components of the information processing system 100 are included herein, one skilled in the art would understand that the components listed herein are examples and are not exclusive. Thus, other components may be included as part of the information processing system 100 within the spirit and scope of the present disclosure.

In one example, one or more processing engines in the information processing system 100 may be aggregated into a single integrated circuit known as a system on a chip (SoC). In one example, the SoC may include the central processing unit (CPU) 120 and other processing engines such as the DSP 130 or the GPU 140. The SoC may also include the memory 160 and the cache memory 170.

In one example, the information processing system 100 may be part of a wireless device in a wireless communication system. For example, the wireless communication system may conform to a wireless network protocol such as 4G LTE (long term evolution), 5G NR (new radio), etc.

In one example, one type of information processing system is an augmented reality (AR) information processing system. For example, the AR information processing system may be used to perform computational tasks for an AR device. One type of AR device is a head mounted display (HMD) which produces an AR image with AR glasses. The AR information processing system may also be used for extended reality (XR) devices and virtual reality (VR) devices which are similar to AR devices.

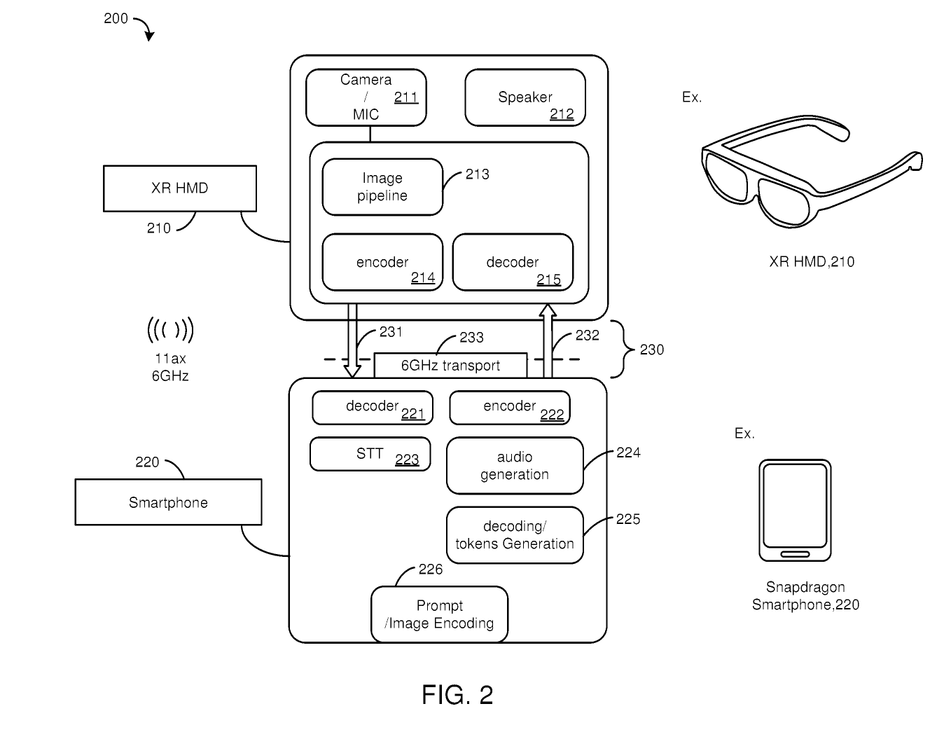

FIG. 2 illustrates an example augmented reality (AR) device 200. In one example, the AR device 200 includes a head mounted device (HMD) 210, an AR computing platform 220 and a wireless communication module 230. In one example, the HMD 210 may be smart glasses. In one example, the AR computing platform 220 may be a smartphone. In one example, the AR computing platform 220 is an application processor. In one example, the application processor is a processing engine which executes user applications (e.g., video, audio, graphics, imagery, etc.)

In one example, the HMD 210 includes an input transducer 211 (e.g., camera, microphone, etc.), an output transducer 212 (e.g., speaker, etc.), an image pipeline 213, a first encoder 214 and a first decoder 215. In one example, the AR computing platform 220 includes a second decoder 221, a second encoder 222, a spin transfer torque (STT) memory 223, an audio generator 224, a decoding/token generator 225 and a prompt/image encoder 226.

In one example, the wireless communication module 230 includes an inbound communication link 231, an outbound communication link 232 and a wireless transport subsystem 233. In one example, the inbound communication link 231 transports information from the HMD 210 to the AR computing platform 220. In one example, the outbound communication link 232 transports information from the AR computing platform 220 to the HMD 210.

In one example, in an AR device, a workload may be distributed across a plurality of processes and threads in an AR processing engine (e.g., an AR computing platform) using an operating system. In one example, the operating system is system software in the AR processing engine (e.g., SoC) which performs overall management and control of the AR information processing system. In one example, the distributed workload may be a fragmented and sporadic workload distribution in the AR processing engine where a plurality of components remains active when not needed. In one example, unnecessary entry and exit into active dc power supply domains result in excessive dc power consumption, thus limiting battery life. In one example, a deep sleep power state, known as rock bottom sleep current (RBSC), may be entered via a power off event. In one example, the deep sleep power state may place each device into a lowest voltage level and current level and lowest clock frequency state to minimize dc power consumption. In one example, the deep sleep power state may place one or more device into a power collapse state (i.e., inactive state).

In one example, for certain operating system use cases, such as a 4 frame per second (fps), 250 ms use case, the distributed workload results in a fragmented distribution with no intelligent exit logic for improved dc power management.

In one example, an intelligent traffic shaper schema or architecture may be used for improved dc power management in an AR device. In one example, the intelligent traffic shaper schema is a zone-based traffic shaper. In one example, a zone is a time interval. In one example, zone-based is an action organized by distinct time intervals. In one example, a traffic shaper is a computing operation which adjusts timing of a plurality of tasks or processes.

In one example, the intelligent traffic shaper schema uses two AR device parameters, a latency and a reference time offset. In one example, latency is a measure of time delay between a directive to start an action (e.g., including commencement of the action) and an expiration of the action. In one example, the time delay is a time period for entering a critical zone and a deep sleep power state. In one example, reference time offset is a time offset between a time reference instant (e.g., sensor start time, image front end (IFE), image processing engine (IPE), image processing (IP), etc.) and a start of an action for a critical zone in a use case boundary or frame boundary.

In one example, the intelligent traffic shaper receives AR use case hints and the two AR device parameters to determine a critical zone. In one example, a plurality of critical zones may be determined, each with two AR device parameters. In one example, the critical zone is a defined time period for the deep sleep power state when individual SOC modules enter a lowest clock frequency and voltage state. In one example, no process or thread is scheduled in the critical zone unless an exception is granted. In one example, the critical zone is used to manage timing of the plurality of processes and threads using a plurality of application programming interface (API) signals (e.g., Linux kernel API signals) for dc power management.

In one example, actions with the plurality of API signals include:
Execution of a Stop signal (e.g., SIGSTOP) and a Continue signal (e.g., SIGCOUNT). In one example, the execution includes a force SIGSTOP (freeze), SIGCOUNT (thawed), force doze, etc. to a /Sys/Power/state kernel.
Execution of a control group (e.g., Cgroup) freeze signal of non-whitelisted workload (e.g., process, task, thread, etc.) or wakeups. In one example, non-whitelisted refers to tasks which may enter the deep sleep power state. That is, a non-whitelisted task is expected to be suppressed with a freeze signal to force a sleep state. That is, a whitelisted task is considered as more important and is allowed to execute in the critical zone. In one example, wakeup refers to exiting the deep sleep power state. In one example a process or task which is marked as a whitelisted task is allowed to execute in the critical zone.
Transmission of a broadcast signal to all processes and threads with the critical zone as feedback for realignment out of the critical zone.
Monitor and hysteresis study of a performance threshold (e.g., junction temperature threshold) during the critical zone for readjustment of the critical zone.

In one example, the intelligent traffic shaper schema may result in significant energy savings (e.g., energy consumption from 41.6 mJ per 250 ms interval to 20.9 mJ per 250 ms) and increased days of usage (DOU) battery life (e.g., 1 additional hour of battery life), based on a use case and weightage of days of usage of user. For example, additional energy savings may be obtained by adjusting temperature thresholds for temperature control logic.

In one example, the intelligent traffic shaper schema shapes workload traffic to align with use case boundaries for each processing engine so that the deep sleep power state may be reached during inactive time durations. In one example, the intelligent traffic shaper schema may remove processes and threads which do not pertain to the use case boundaries so that the deep sleep power state is maintained over a longer time duration.

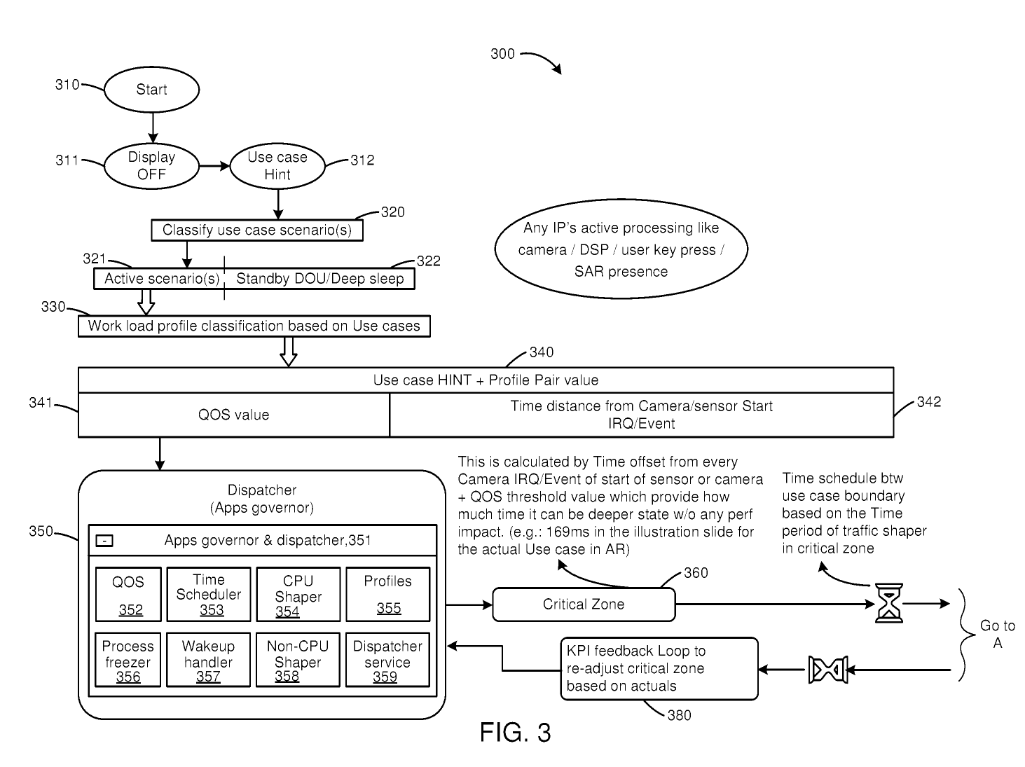

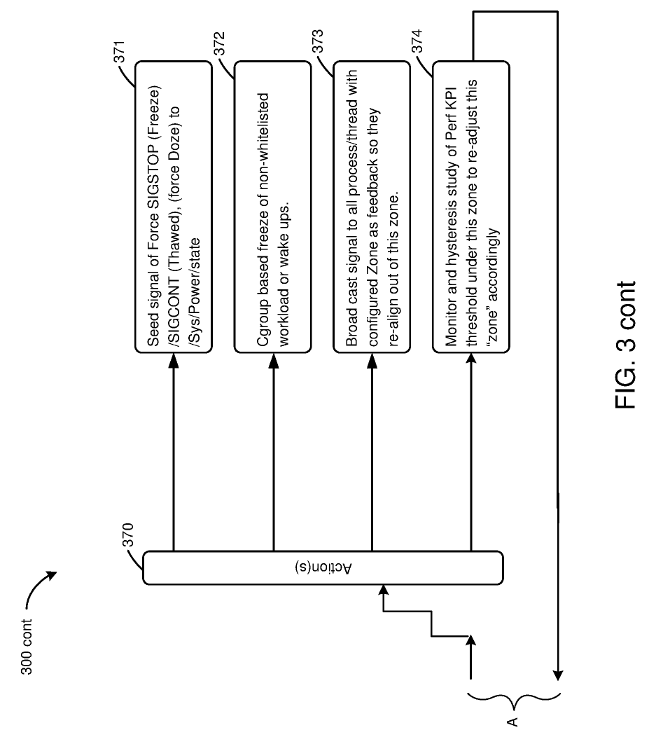

FIG. 3 illustrates an example of an intelligent traffic shaper schema 300. In one example, the schema 300 commences with a start action 310. In one example, the start action 310 is followed by a display off action 311 and a use case hint directive 312. In one example, the schema 300 continues with a classify use case scenario action 320. In one example, the classify use case scenario action 320 is followed by an active scenario 321 and a standby days of use (DOU)/deep sleep action 322.

In one example, the schema 300 continues with a workload profile classification based on use case action 330. In one example, the schema 300 continues with a use case hint and profile pair values action 340. For example, the use case hint and profile pair values action 340 is followed by a latency module 341 and a reference time offset module 342.

In one example, the schema 300 continues with a dispatcher action 350. In one example, the dispatcher action 350 includes an application governor and dispatcher 351, a quality of service (QoS) module 352, a time scheduler module 353, a processor traffic shaper module 354, a profile module 355, a process freezer module 356, a wakeup handler module 357, a non-processor traffic shaper module 358 and a dispatch service module 359. In one example, the QoS module 352 determines a latency parameter and the time scheduler module 353 determines a reference time offset parameter. In one example, the schema 300 continues with a determine critical zone action 360. In one example, the determine critical zone action 360 uses the latency parameter and the frame reference time offset parameter to determine a critical zone.

In one example, the schema 300 continues with an execute action 370. In one example, the execute action 370 generates the following plurality of API signals: Stop signal (e.g., SIGSTOP) and Continue signal (e.g., SIGCONT) Control group (e.g., Cgroup) freeze signal of non-whitelisted workload or wakeups Broadcast signal to all processes and threads with critical zone as feedback for realignment out of the critical zone Monitor and hysteresis signal of performance threshold (e.g., junction temperature threshold) during the critical zone for readjustment of the critical zone.

Stop signal (e.g., SIGSTOP) and Continue signal (e.g., SIGCONT)

Control group (e.g., Cgroup) freeze signal of non-whitelisted workload or wakeups

Broadcast signal to all processes and threads with critical zone as feedback for realignment out of the critical zone

Monitor and hysteresis signal of performance threshold (e.g., junction temperature threshold) during the critical zone for readjustment of the critical zone.

In one example, the schema 300 continues with a feedback loop action 380 to adjust the critical zone based on actual data. In one example, the feedback loop action 380 sends broadcast signals to all processes and threads for task realignment out of the critical zone or the adjusted critical zone. In one example, the adjusted critical zone is fed back to the dispatcher action 350. In one example, an adjusted critical zone is equal to the critical zone (i.e., null adjustment). In one example, actual data includes a real time workload, a performance key performance indicator (KPI), a junction temperature, a skin temperature, a region of interest (ROI) object, a user intervention parameter, audio quality, image quality, etc.

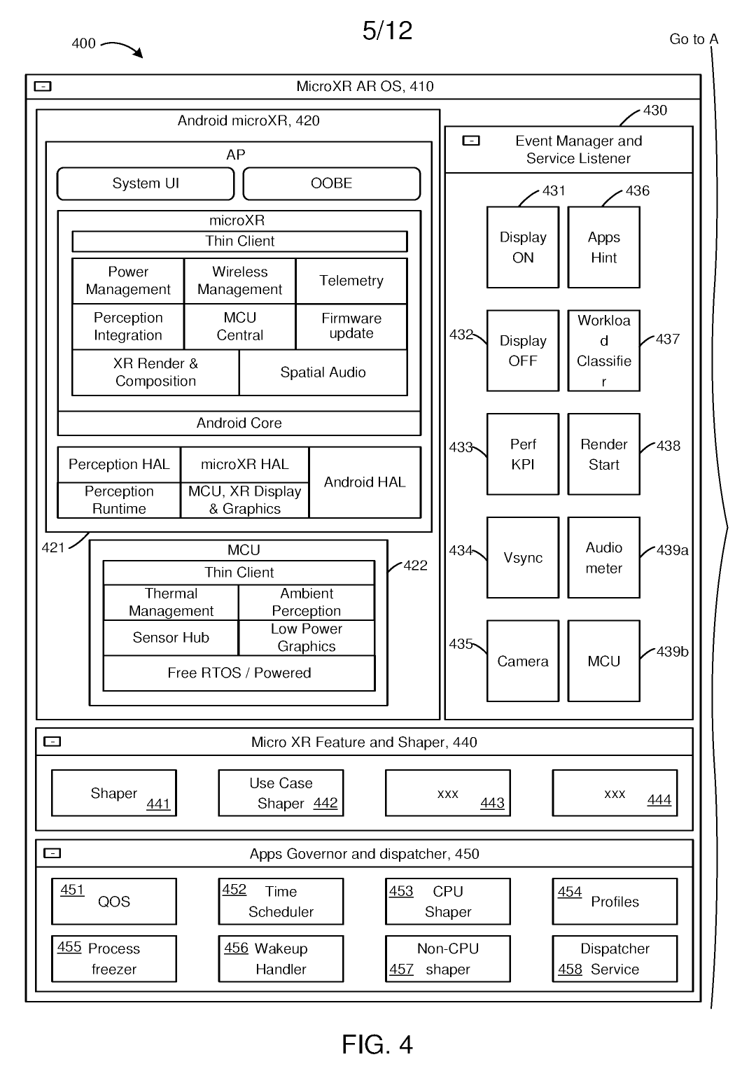

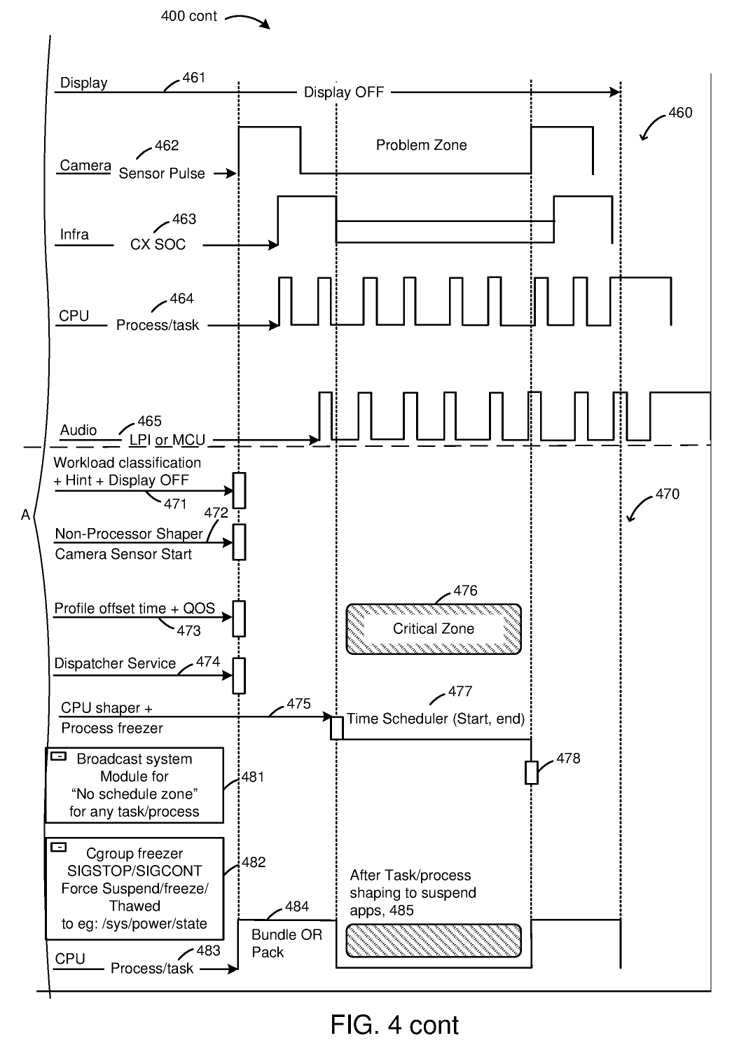

FIG. 4 illustrates an example overview of an intelligent traffic shaping 400. In one example, the intelligent traffic shaping 400 includes an extended reality (XR) processing architecture 410. In one example, the XR processing architecture 410 includes an XR processing engine 420, an event manager and service listener module 430, a feature and shaper module 440 and an application governor and dispatcher module 450. In one example, intelligent traffic shaping is used to facilitate transition to a deep sleep power state.

In one example, the XR processing engine 420 includes an application processor (AP) 421 and a microcomputer unit (MCU) 422. In one example, the event manager and service listener module 430 includes a display on function 431, a display off function 432, a performance key performance indicator (KPI) function 433, a vertical synchronization function 434, a camera function 435, an application hint function 436, a workload classifier function 437, a render start function 438, an audio meter function 439a and a local microcomputer unit (MCU) 439b.

In one example, the feature and shaper module 440 includes a non-processor shaper function 441, a use case shaper function 442, a first auxiliary function 443 and a second auxiliary function 444. In one example, the non-processor shaper function 441 monitors a camera start and offset time to activate a dispatcher which tracks the critical zone. In one example, during the critical zone, workloads may be shifted outside of the critical zone using broadcast signals or essential software optimizations. For example, the broadcast signals include seed signals such as force SIGSTOP (freeze), SIGCONT (thawed), force doze, etc. to a /Sys/Power/state kernel. In one example, /Sys/Power/state is a software kernel (software module) in Unix-Linux.

In one example, the application governor and dispatcher module 450 includes a QoS function 451, a time scheduler function 452, a processor shaper function 453, a profiles function 454, a process freezer function 455, a wakeup handler function 456, a non-processor shaper function 457 and a dispatcher service function 458.

In one example, the overview of intelligent traffic shaping 400 includes a plurality of API signals 460 including a display signal 461, a sensor pulse signal 462, an infra signal 463, a process/task signal 464 and an audio signal 465.

In one example, the overview of intelligent traffic shaping 400 includes a plurality of smart dispatcher signals 470 including a workload classification & hint signal 471, a non-processor shaper signal 472, a profile offset time & QoS signal 473, a dispatcher service signal 474, a processor shaper signal 475, a time scheduler start signal 477 and a time scheduler end signal 478. In one example, a critical zone 476 is defined as a time boundary for the deep sleep power state.

In one example, the overview of intelligent traffic shaping 400 includes a broadcast system module 481 used to indicate a no schedule zone for any task or process during the critical zone and a control group freezer module 482 used to halt and restart a task or process during the critical zone. In one example, a process/task signal 483 and a bundle/pack signal 484 may be used to manage a start and duration of task suspension zone 485. In one example, the process/task signal 483 may be a seed signal such as force SIGSTOP (freeze), SIGCONT (thawed) force doze, etc. to a /Sys/Power/state kernel.

In one example, the control group freezer module 482 may be used to send a freeze signal to force a task or process to suspend operations during the critical zone. In one example, the freeze signal may be sent to enable a sleep state without utilizing processor resources.

In one example, intelligent traffic shaping may be used for processor traffic shaping to facilitate a transition to a deep sleep power state (e.g., rock bottom sleep current (RBSC)). In one example, a traffic shaper monitors a sensor (e.g., camera) start time and offset time to activate a dispatcher which tracks the critical zone for the deep sleep power state.

In one example, during a designated time interval, workloads may be shifted outside of the critical zone through broadcasting or through essential software optimizations. In one example, to enable processes which are active to enter a sleep state without using processor resources, the traffic shaper may send a freeze signal to force a task/process to suspend during the designated time interval.

In one example, the traffic shaper may leverage a doze mode to induce sleep during this timeframe. In one example, the traffic shaper aids in shaping processor workload during the designated time interval, allowing the processor to reach the deep sleep power state while enabling other components to adopt a similar efficiency strategy.

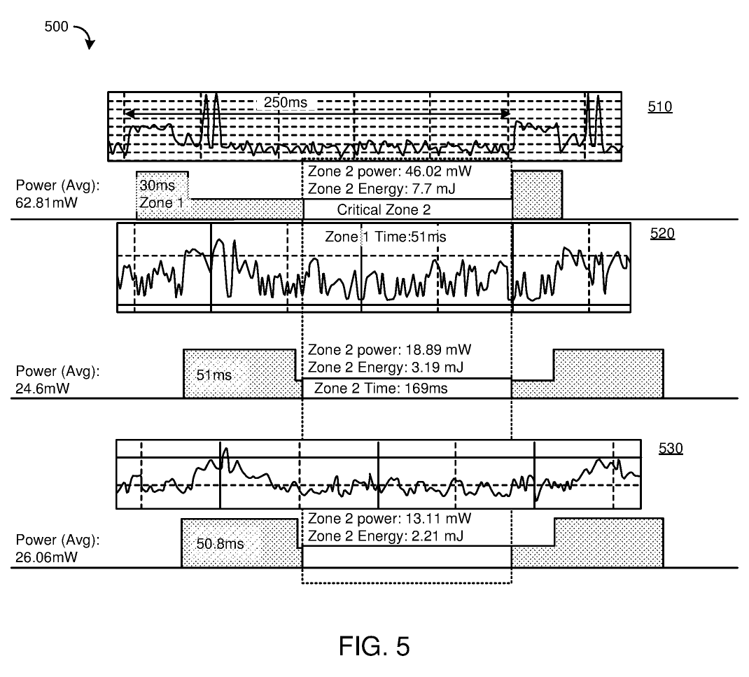

FIG. 5 illustrates an example of a first set 500 of performance curves. In one example, the first set 500 of performance curves includes a first power trace 510, a second power trace 520 and a third power trace 530. In one example, the first power trace 510 shows a power profile for a first module, the second power trace 520 shows a power profile for a second module and the third power trace 530 shows a power profile for a third module. In one example, high power transients with a periodicity of approximately 250 ms appear on the first power trace 510, the second power trace 520 and the third power trace 530.

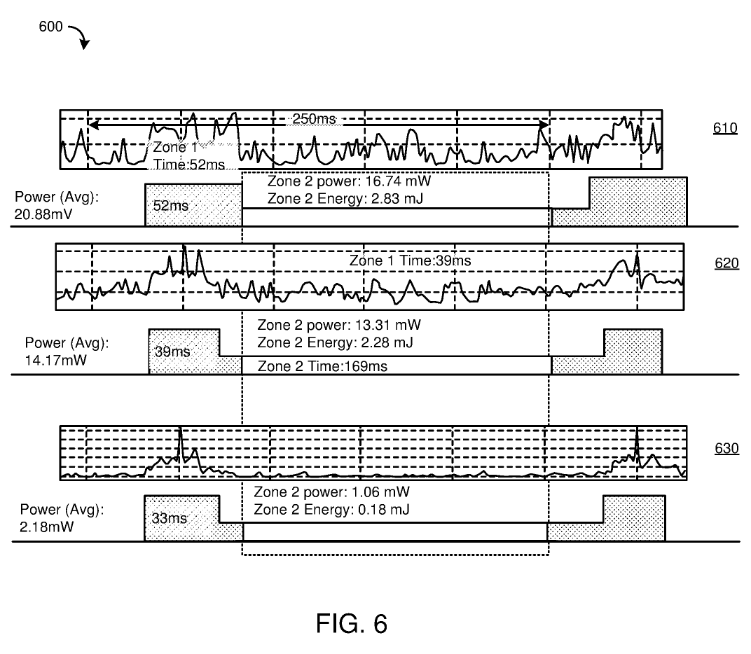

FIG. 6 illustrates an example of a second set 600 of performance curves. In one example, the second set 600 of performance curves includes a fourth power trace 610, a fifth power trace 620 and a sixth power trace 630. In one example, the fourth power trace 610 shows a power profile for a fourth module, the fifth power trace 620 shows a power profile for a fifth module and the sixth power trace 630 shows a power profile for a sixth module. In one example, high power transients with a periodicity of approximately 250 ms appear on the fourth power trace 610, fifth power trace 620 and the sixth power trace 630.

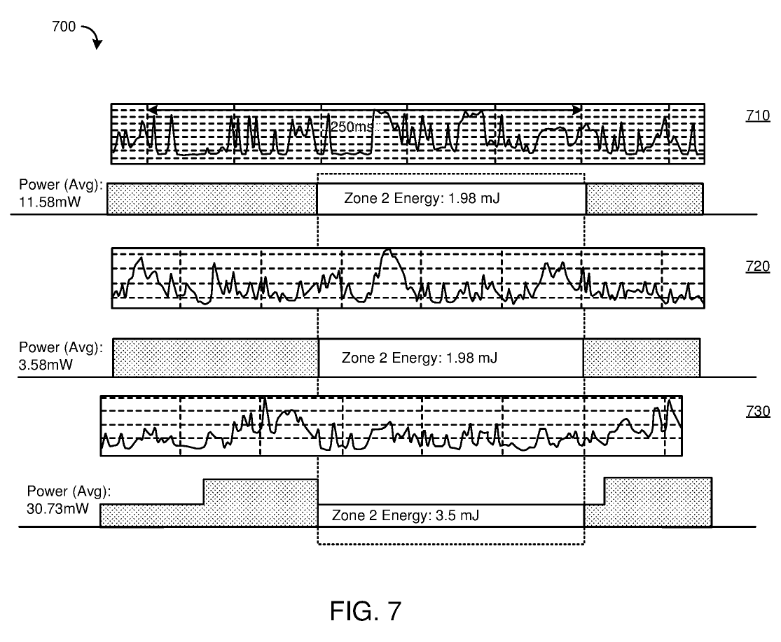

FIG. 7 illustrates an example of a third set 700 of performance curves. In one example, the third set 700 of performance curves includes a seventh power trace 710, an eighth power trace 720 and a ninth power trace 730. In one example, the seventh power trace 710 shows a power profile for a seventh module. In one example, the eighth power trace 720 shows a power profile for an eighth module. In one example, the ninth power trace 730 shows a power profile for an ninth module. In one example, high power transients with a periodicity of approximately 250 ms appear on the seventh power trace 710, eighth power trace 720 and the ninth power trace 730.

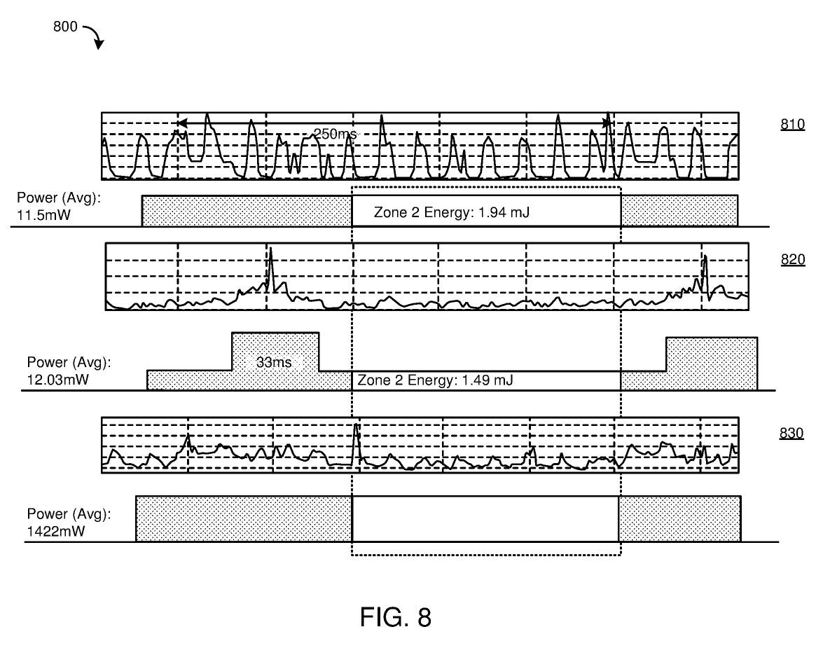

FIG. 8 illustrates an example of a fourth set 800 of performance curves. In one example, the fourth set 800 of performance curves includes a tenth power trace 810, an eleventh power trace 820 and a twelfth power trace 830. In one example, the tenth power trace 810 shows a power profile for a tenth module. In one example, the eleventh power trace 820 shows a power profile for an eleventh module. In one example, the twelfth power trace 830 shows a power profile for a twelfth module. In one example, high power transients with a periodicity of approximately 250 ms appear on the tenth power trace 810, the eleventh power trace 820 and the twelfth power trace 830.

In one example, FIGS. 5-8 illustrate examples of a plurality of power profiles for a plurality of modules. In one example, the plurality of power profiles are initially sporadic and asynchronous with each other. In one example, intelligent traffic shaping synchronizes the plurality of power profiles and establishes a critical zone for the plurality of modules.

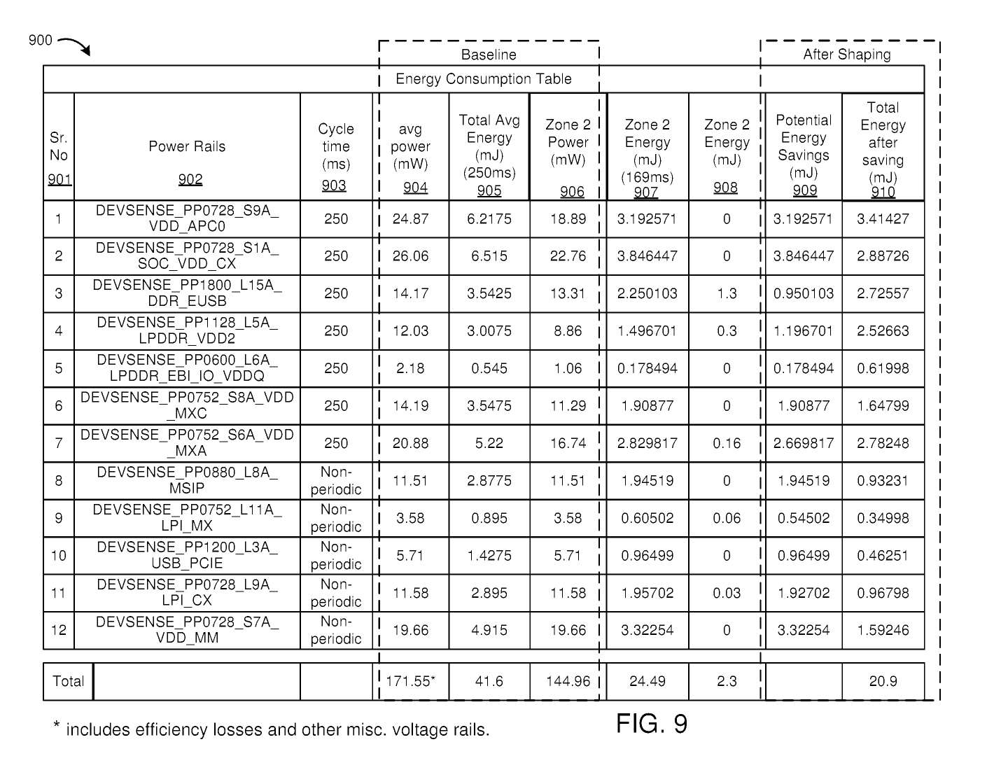

FIG. 9 illustrates an example energy consumption table 900. In one example, the energy consumption table 900 includes power string identifier column 901, a power rail label column 902, a cycle time column 903, a baseline average power column 904, a baseline average energy column 905, a baseline zone 2 power column 906, a first zone 2 energy column 907, a second zone 2 energy column 908, a potential energy savings column 909 and a total energy column 910. In one example, a baseline average energy consumption of 41.6 mJ over 250 ms is tabulated for a baseline configuration and a shaped average energy consumption of 20.9 mJ over 250 ms is tabulated for a shaped configuration.

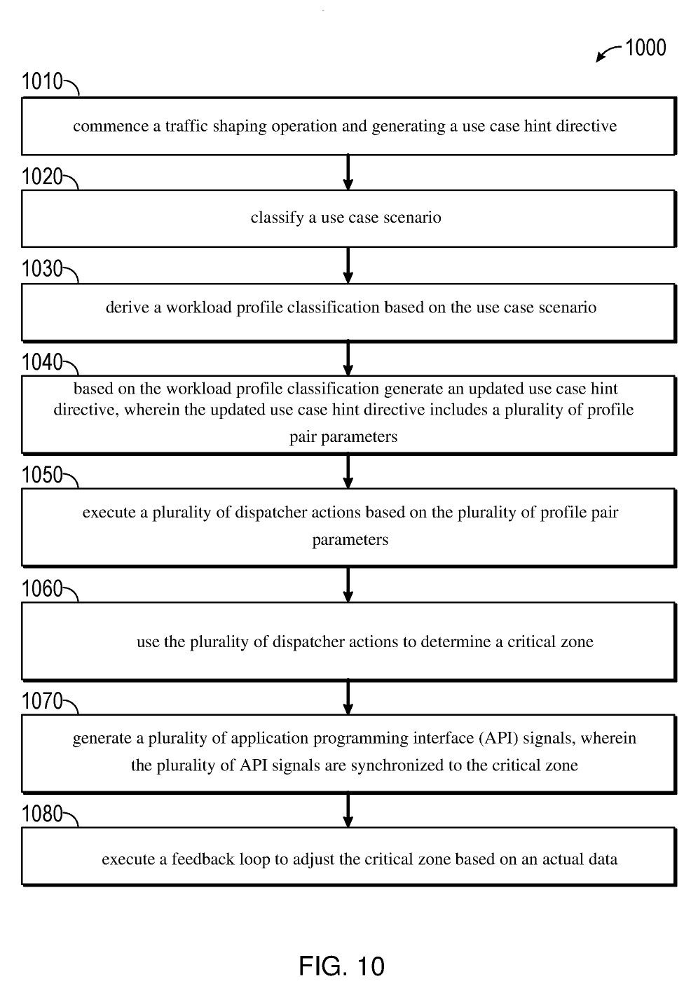

FIG. 10 illustrates an example flow diagram 1000 for implementing intelligent traffic shaping. In block 1010, commence a traffic shaping operation and generate a use case hint directive. In one example, a traffic shaping operation is commenced and a use case hint directive is generated. In one example, the use case hint directive is a stimulus for a use case scenario classification action. In one example, the step of block 1010 is performed by one or more of the following: a controller, a non-transitory memory, a central processing unit (CPU), a graphics processing unit (GPU), a display processing unit (DPU), a processing engine, a microcontroller, a processor, a computing platform, etc.

In block 1020, classify a use case scenario. In one example, a use case scenario is classified. In one example, classifying the use case scenario action determines an active scenario. In one example, classifying the use case scenario determines a standby days of use (DOU) state. In one example, classifying the use case scenario determines a deep sleep power state. In one example, the step of block 1020 is performed by one or more of the following: an application processor, a non-transitory memory, a central processing unit (CPU), a graphics processing unit (GPU), a display processing unit (DPU), a processing engine, a microcontroller, a processor, a computing platform, etc.

In block 1030, derive a workload profile classification based on the use case scenario. In one example, a workload profile classification is derived based on the use case scenario. In one example, the workload profile classification describes active and inactive time periods for a plurality of tasks and a plurality of processes. In one example, the step of block 1030 is performed by one or more of the following: an application processor, a non-transitory memory, a central processing unit (CPU), a graphics processing unit (GPU), a display processing unit (DPU), a processing engine, a microcontroller, a processor, a computing platform, etc.

In block 1040, based on the workload profile classification generate an updated use case hint directive, wherein the updated use case hint directive includes a plurality of profile pair parameters. In one example, based on the workload profile classification, an updated use case hint directive is generated, wherein the updated use case hint directive includes a plurality of profile pair parameters.

In one example, the use case hint directive is a basis for the updated use case hint directive. In one example, the plurality of profile pair parameters includes a latency value and a reference time offset value. In one example, the latency value is a measure of time delay between a directive to start an action (e.g., including commencement of the action) and an expiration of the action. In one example, the time delay is a time period for entering a critical zone and a deep sleep power state. In one example, the reference time offset value is a time offset between a time reference instant (e.g., sensor start time, image front end (IFE), image processing engine (IPE), image processing (IP), etc.) and a start of an action for a critical zone in a use case boundary or frame boundary. In one example, the step of block 1040 is performed by one or more of the following: a controller, a non-transitory memory, a central processing unit (CPU), a graphics processing unit (GPU), a display processing unit (DPU), a processing engine, a microcontroller, a processor, a computing platform, etc.

In block 1050, execute a plurality of dispatcher actions based on the plurality of profile pair parameters. In one example, a plurality of dispatcher actions is executed based on the plurality of profile pair parameters. In one example, the plurality of dispatcher actions includes an application governor and dispatcher, a quality of service (QoS) action, a time scheduler action, a processor traffic shaper action, a profile action, a process freeze action, a wakeup handler action, a non-processor traffic shaper action and a dispatch service action. In one example, the QoS action determines the latency value and the time scheduler action determines the reference time offset value. In one example, the step of block 1050 is performed by one or more of the following: a controller, a non-transitory memory, a central processing unit (CPU), a graphics processing unit (GPU), a display processing unit (DPU), a processing engine, a microcontroller, a processor, a computing platform, etc.

In block 1060, use the plurality of dispatcher actions to determine a critical zone. In one example, the plurality of dispatcher actions is used to determine a critical zone. In one example, the determination uses the latency value and the reference time offset value to determine the critical zone. In one example, the critical zone is a time period for the deep sleep power state. In one example, the step of block 1060 is performed by one or more of the following: an application processor, a non-transitory memory, a central processing unit (CPU), a graphics processing unit (GPU), a display processing unit (DPU), a processing engine, a microcontroller, a processor, a computing platform, etc.

In block 1070, generate a plurality of application programming interface (API) signals, wherein the plurality of API signals are synchronized to the critical zone. In one example, a plurality of application programming interface (API) signals is generated, wherein the plurality of API signals are synchronized to the critical zone. In one example, the plurality of API signals include a stop signal (e.g., SIGSTOP), a continue signal (e.g., SIGCONT), a control group (e.g., Cgroup) freeze signal, a broadcast signal to all processes and threads with a critical zone as feedback for realignment out of the critical zone, a monitor/hysteresis signal of performance threshold (e.g., junction temperature threshold , a key performance indicator (KPI) such as audio quality, latency, user interface experience, etc.) under the critical zone for readjustment of the configured zone. In one example, a process is a thread; that is, the two terms are interchangeable. Although the examples of the present disclosures may disclose “a” critical zone, one skilled in the art would understand that the present disclosure is not limited to a single critical zone and that more than one critical zone are within the scope and spirit of the present disclosure.

In one example, synchronized to the critical zone means signal state transitions of the plurality of API signals are aligned to time boundaries of the critical zone. In one example, signal state transitions are events where signal levels change amplitude state (e.g., low/high or high/low). In one example, time boundaries of the critical zone include a start time and an end time. In one example, the step of block 1070 is performed by one or more of the following: an application processor, a non-transitory memory, a central processing unit (CPU), a graphics processing unit (GPU), a display processing unit (DPU), a processing engine, a microcontroller, a processor, a computing platform, etc.

In block 1080, execute a feedback loop to adjust the critical zone based on an actual data. In one example, a feedback loop is executed to adjust the critical zone based on an actual data. In one example, the adjusted critical zone is fed back as an additional dispatcher action. In one example, the feedback loop conveys information to the dispatcher to adjust the critical zone (e.g., critical zone boundaries). In one example, the adjusting of the critical zone is part of the traffic shaping operation. In one example, the step of block 1080 is performed by one or more of the following: an application processor, a non-transitory memory, a central processing unit (CPU), a graphics processing unit (GPU), a display processing unit (DPU), a processing engine, a microcontroller, a processor, a computing platform, etc.

Kathik: please note that paragraphs [0069]-[0077] paraphrase the claims. The terms in the claims, such as those listed in your comments below, have already been defined and explained in the other parts of the specification text. Thus, it is more advantageous to leave the claim terms as written without adding specific definitions in the claim to allow for broader interpretation (if needed) to cover competitor’s infringing products. Also, it is not necessary to define the same term more than once in the specification.

In one example, the plurality of profile pair parameters includes a latency value and a reference time offset value. In one example, the method further includes using a latency value and a reference time offset value to determine the critical zone. In one example, the reference time offset value is a time offset between a time reference instant and a start of an action for the critical zone in a use case boundary or a frame boundary. In one example, the latency value is a measure of a time delay between a directive to start an action and an expiration of the action

In one example, the method further includes generating an updated use case hint directive based on a workload profile classification, wherein the updated use case hint directive includes the plurality of profile pair parameters. In one example, the directive is the updated use case hint directive. In one example, the critical zone is a time period for a deep sleep power state.

In one example, the method further includes deriving the workload profile classification based on a use case scenario. In one example, the method further includes classifying the use case scenario. In one example, the method further includes commencing a traffic shaping operation; and generating a use case hint directive, wherein the use case hint directive is a basis for the updated use case hint directive. In one example, the method further includes feeding back the actual data to determine an adjusted critical zone.

In one example, the present disclosure discloses an apparatus including: a non-transitory memory configured to store a plurality of profile pair parameters; and an application processor coupled to the non-transitory memory, the application processor configured to determine a critical zone, to generate a plurality of application programming interface (API) signals, to execute a feedback loop to adjust the critical zone based on an actual data to create an adjusted critical zone, and to sending the plurality of API signals to at least one process for task realignment out of the critical zone or the adjusted critical zone.

In one example, the plurality of API signals are aligned to one or more time boundaries of the critical zone. In one example, the application processor is further configured to use a plurality of dispatcher actions to determine the critical zone.

In one example, the apparatus further includes a controller coupled to the non-transitory memory, the controller configured to generate an updated use case hint directive, wherein the updated use case hint directive includes the plurality of profile pair parameters. In one example, the plurality of profile pair parameters includes a latency value and a reference time offset value. In one example, the latency value is a measure of a time delay between a directive to start an action and an expiration of the action., and the reference time offset value is a time offset between a time reference instant start time and an end time instant.

In one example, the application processor is further configured to derive a workload profile classification based on a use case scenario, and wherein classifying the use case scenario determines a deep sleep power state.

a non-transitory computer-readable medium storing computer executable code, operable on a device including at least one processor and at least one memory coupled to the at least one processor, wherein the at least one processor is configured to implement traffic shaping, the computer executable code including: instructions for causing a computer to execute a plurality of dispatcher actions based on a plurality of profile pair parameters; instructions for causing the computer to use the plurality of dispatcher actions to determine a critical zone; instructions for causing the computer to generate a plurality of application programming interface (API) signals, wherein the plurality of API signals are synchronized to the critical zone; and instructions for causing the computer to execute a feedback loop to adjust the critical zone based on an actual data.

In one aspect, one or more of the steps for providing traffic shaping in FIG. 10 may be executed by one or more processors which may include hardware, software, firmware, etc. The one or more processors, for example, may be used to execute software or firmware needed to perform the steps in the flow diagram of FIG. 10. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A method comprising:
executing a plurality of dispatcher actions based on a plurality of profile pair parameters;
using the plurality of dispatcher actions to determine a critical zone;
generating a plurality of application programming interface (API) signals, wherein the plurality of API signals are synchronized to the critical zone;
executing a feedback loop to adjust the critical zone based on an actual data to create an adjusted critical zone; and
sending the plurality of API signals to at least one process for task realignment out of the critical zone or the adjusted critical zone.

2. The method of claim 1, wherein the plurality of profile pair parameters includes a latency value and a reference time offset value.

3. The method of claim 1, further comprising using a latency value and a reference time offset value to determine the critical zone.

4. The method of claim 3, wherein the reference time offset value is a time offset between a time reference instant and a start of an action for the critical zone in a use case boundary or a frame boundary.

5. The method of claim 3, wherein the latency value is a measure of a time delay between a directive to start an action and an expiration of the action.

6. The method of claim 5, further comprising generating an updated use case hint directive based on a workload profile classification, wherein the updated use case hint directive includes the plurality of profile pair parameters.

7. The method of claim 6, wherein the directive is the updated use case hint directive.

8. The method of claim 6, wherein the critical zone is a time period for a deep sleep power state.

9. The method of claim 8, further comprising deriving the workload profile classification based on a use case scenario.

10. The method of claim 9, further comprising classifying the use case scenario.

11. The method of claim 10, further comprising:
commencing a traffic shaping operation; and
generating a use case hint directive, wherein the use case hint directive is a basis for the updated use case hint directive.

12. The method of claim 11, further comprising feeding back the actual data to determine an adjusted critical zone.

13. An apparatus comprising:
a non-transitory memory configured to store a plurality of profile pair parameters; and
an application processor coupled to the non-transitory memory, the application processor configured to determine a critical zone, to generate a plurality of application programming interface (API) signals , to execute a feedback loop to adjust the critical zone based on an actual data to create an adjusted critical zone, and to sending the plurality of API signals to at least one process for task realignment out of the critical zone or the adjusted critical zone.

14. The apparatus of claim 13, wherein the plurality of API signals are aligned to one or more time boundaries of the critical zone.

15. The apparatus of claim 13, wherein the application processor is further configured to use a plurality of dispatcher actions to determine the critical zone.

16. The apparatus of claim 15, further comprising a controller coupled to the non-transitory memory, the controller configured to generate an updated use case hint directive, wherein the updated use case hint directive includes the plurality of profile pair parameters.

17. The apparatus of claim 16, wherein the plurality of profile pair parameters includes a latency value and a reference time offset value.

18. The apparatus of claim 17, wherein the latency value is a measure of a time delay between a directive to start an action and an expiration of the action and the reference time offset value is a time offset between a time reference instant and a start of an action for the critical zone in a use case boundary or a frame boundary.

19. The apparatus of claim 16, wherein the application processor is further configured to derive a workload profile classification based on a use case scenario, and wherein classifying the use case scenario determines a deep sleep power state.

20. A non-transitory computer-readable medium storing computer executable code, operable on a device comprising at least one processor and at least one memory coupled to the at least one processor, wherein the at least one processor is configured to implement traffic shaping, the computer executable code comprising:
instructions for causing a computer to execute a plurality of dispatcher actions based on a plurality of profile pair parameters;
instructions for causing the computer to use the plurality of dispatcher actions to determine a critical zone;
instructions for causing the computer to generate a plurality of application programming interface (API) signals, wherein the plurality of API signals are synchronized to the critical zone;
instructions for causing the computer to execute a feedback loop to adjust the critical zone based on an actual data to create an adjusted critical zone; and
instructions for causing the computer to send the plurality of API signals to at least one process for task realignment out of the critical zone or the adjusted critical zone.
